(19) United States
(12) Patent Application Publication
(10) Pub. No.: US 2010/0135537 A1
(43) Pub. Date: Jun. 3, 2010

(54) METHOD AND EQUIPMENT FOR EVALUATION OF RECYCLED PULP AND PULP

(76) Inventors: Chun Ye, Kajaani (FI); Ari Vilenius, Kajaani (FI); Matti-Paavo Saren, Kajaani (FI)

Correspondence Address: FASTH LAW OFFICES (ROLF FASTH), 26 PINECREST PLAZA, SUITE 2, SOUTHERN PINES, NC, 28387-4301, US

(21) Appl. No.: 12/447,964

(22) PCT Filed: Oct. 31, 2007
(86) PCT No.: PCT/FI07/00264

§ 371 Date: Jan. 27, 2010

(30) Foreign Application Priority Data
Nov. 1, 2006 (FI) 20060959

(51) Int. Cl. G06K 9/62; G01J 4/00; G01N 1/10

(52) U.S. Cl. 382/110; 356/364; 356/246

(57) ABSTRACT

The non-destructive method is for measurement of recycled pulp or pulp immersed in suspension that enables real-time or on-line evaluation of particles in recycled pulp or pulp, especially for evaluation of particles including inks contained in recycled or de-inked pulp for their characteristics related to sizes, shapes, areas, amount, concentration, absorption coefficients, spectral characteristics such as color locus (L*, a*, b* values) and parameters, which are equivalent to an effective residual ink content (ERIC) or the ink elimination (IE) or detachment (ID), but independent of the size distribution of inks. The method can additionally be used for real-time or on-line recognizing inks from the other particles and distinguishing inks, which are already detached from or still attached to fibers and identification of the pulp fibers and fiber-based particles in recycled pulp or pulp from the non-fiber particles.

### FIELD OF THE INVENTION

This invention relates to a method and equipment for real-time and/or on-line evaluation of recycled pulp or pulp immersed in suspension and especially for measurement of particles including inks contained in recycled pulp.

### BACKGROUND OF THE INVENTION

Recycled pulp contains wood fibers and various particles e.g. inks. The presence of ink particles influences the cleanliness, brightness and color of recycled paper. The deinkability of recycled paper describes the degrees of printing ink removal by a deinking process. Evaluation of the deinkability of recycled or deinked pulp includes measurements of the effective residual ink concentration (ERIC value), the ink elimination (IE), the ink detachment (ID), the deinkability factor (DEM) and the brightness (TAPPI T 567 method “Determination of effective residual ink concentration (eric) by infrared reflectance measurement”, http://www.ingede.de/ingindxe/methods/meth01pe.pdf3, http://www.ingede.de/ingindxe/methods/meth02pe.pdf). Previous methods for the evaluation of the deinkability of recycled pulp use and measure specially prepared dry handsheets of pulp as the sample (e.g. B. D. Jordan and S. J. Popson, Journal of Pulp and Paper Science, 20 (6): 161 (June 1994)).

A typical disadvantage of the previous methods is that they measure a pulp handsheet as an entire sample with the measurement results highly dependent on the sample analyzed and do not give information about fibers and particles contained in the handsheet sample. The ERIC value gives no information about the actual quantity of inks and its measurement depends on the distribution of ink particle sizes, and on the agglomeration effects such as deinking chemistry. Also as known, the brightness is not only affected by the presence of ink but also by the other (chemical) substances such as lignin and dye, either particles or dissolved, which absorb light mainly in visible range. So a brightness measurement on an entire pulp sample cannot make a difference between the inks, which are already detached from or still attached to fibers. Inks detached from the fibers can be removed by flotation while those still attached to the fibers cannot or are difficult to be removed. Method for distinguishing whether ink particles are free or attached to the fibers will help optimizing the pulping process so that a lot of energy, chemicals and fibers can be saved. In addition, the previous methods for evaluation of the deinkability are offline methods, requiring time-consuming sample preparation, and unable to be used for effective fiber quality control and interactive process optimization.

As a possible solution for real-time or on-line measurement of recycled pulp, methods were developed, which use and measure the suspension of pulp fibers as the sample instead of the thy pulp handsheet. An earlier described system is BT-5300 brightness sensor from BTG (Klaus Villforth: Brightness, Ink Elimination and ERIC value—relevant parameters for evaluating deinking processes, UpTimes, Pulp and Paper Process News, No 12, BTG Pulp & Paper Sensors AB, Sweden), which uses an optical arrangement that measures light reflectance of four pulsating light sources at fiber suspensions for determination of the optical properties of the suspensions. A more recently developed spectrometer for fiber suspension is reported by Villforth et al (Villforth, H. K. & Gottsching, L., ipw. International Paperworld, ISSN: 1615-1720, Germany, 2003, no. 6, p. 61-67), which measures light scattering power, reflection factors and absorption coefficients in analogy to the measurement of a pulp handsheet sample. The methods of BTG and Villforth et al are based on the reflectance measurement and they are further development of the methods of measuring the pulp handsheet sample with the pulp handsheet sample replaced by a fiber suspension. For the methods of BTG and Villforth et al, quick or on-line measurement is possible because no sample preparation is needed. However, these methods measure a fiber suspension as an entire sample and cannot give information about fibers and particles contained in the suspension so that they are subjected to the same disadvantages of the methods using the pulp handsheet sample as described above.

As the prior art demonstrates, the most methods so far available for measurement of recycled pulp are limited for use in laboratories and there are a few real-time or on-line measurement methods, which are restricted for their liabilities.

Therefore, it is an object of the present invention to provide a method and equipment as a solution for real-time and/or on-line measurement of recycled or deinked pulp or pulp immersed in suspension, which is capable of real-time assessment of optical characteristics of particles including inks contained in the suspension and distinguishing which inks are already detached from fibers and which ones not, still attached to fibers.

Another object of the present invention to provide a method and equipment for real-time distinguishing the fibers and fiber-based particles from the non-fiber particles in recycled pulp or pulp to recognize which particles are fibrous and which ones are non-fiber particles.

### SUMMARY OF THE INVENTION

The method of the invention is intended for measurement of recycled pulp or pulp, mainly for real-time evaluation of recycled pulp or pulp. The method employs equipment that contains at least one imaging channel and comprises elements including a light source, an entrance polarizer, a sample unit, an exit polarizer, a filter, at least one image sensor and an image-processing unit for image and data processing. The method of the invention comprises the steps of placing said recycled pulp or pulp in said sample unit, generating at least one image of fibers and particles contained said recycled pulp or pulp selected for measurement with said equipment, and using said image(s) for measuring and evaluating fibers and particles selected for measurement.

In a preferable embodiment, the method of the invention is for evaluation of recycled pulp or pulp in laboratory, using equipment containing one imaging channel, constructed with only one image sensor and said elements above. According to the method, three images of fibers and particles of said recycled pulp or pulp are sequentially acquired with said polarizer oriented parallel and perpendicular to said entrance polarizer and with said exit polarizer replaced by said filter, which preferably is a spectral filter in the near-infrared range, typically at 950 nm. These images are processed and compared with one another for measuring and evaluating said fibers and particles selected for measurement.

In another preferable embodiment, said equipment has two imaging channels constructed with two image sensors and a beamsplitter in addition to said elements above and such equipment is used in the method of the invention for real-time evaluation of recycled pulp or pulp. The method of the invention comprises the steps of generating and forming images of fibers and particles of said recycled pulp or pulp selected for measurement behind said exit polarizer in one of said channels connected to said first image sensor and behind said filter in the other channel connected to said second image sensor, respectively, detecting said image of fibers and particles in said channel connected to said first image sensor by said first image sensor, using and processing said image of said first image sensor for measuring and evaluating fibers and particles in said image of said first image sensor, detecting said image of fibers and particles in said channel connected to said second image sensor by said second image sensor, and using and processing said image of said second image sensor for measuring and evaluating fibers and particles in said image of said second image sensor, and comparing and processing said images of said first and second image sensors for measuring and evaluating fibers and particles in said images of said first and second image sensors.

The preferable embodiments of the invention have the characteristics of the subclaims. In one such embodiment, the elements of the equipment may additionally include a first quarter-wave retarder and a second quarter-wave retarder.

Said light source generates light beam having a broad spectrum in a predetermined wavelength range. For example, it can be a white light source or an assembly comprising proper laser diode or diodes at the wavelengths as wished.

The equipment of the invention is developed based on the method of the invention, which functions as a two-channel imaging spectrometer, capable of simultaneously generating two micrographs of fibers and particles of recycled pulp or pulp preferably immersed in suspension. Fibers and particles are illuminated by a light beam of the light source having a broad spectrum in a predetermined wavelength range, preferably the visible and near infrared range, and the light emergent from the sample is divided by a beamsplitter into two component beams in two channels, which are detected by two image sensors, preferably CCD or CMOS cameras, respectively. In an embodiment of the invention, the components in one of the two channels include two quarter-wave retarders inserted between and oriented at 45° to a pair of parallel or perpendicular polarizers with the sample suspension placed between the retarders. This channel of the equipment is capable of creating an image of fibers and particles in the suspension with a bright or dark background, which is insensitive to the fibers' orientation and formed or determined only by the fibers' properties related to the polarized light. In the second channel of the equipment, there is no exit polarizer used behind the sample, instead a near-infrared bandpass filter, preferably of 950 nm, so that the second channel works as a photometer. In the image detected by the image sensor of this channel, only ink particles contained in the sample are visible because inks absorb light at 950 nm several orders stronger than fibers and non-ink particles.

By comparing the images of the two channels of the equipment, it is feasible to recognize which particles are inks and to distinguish which inks are already detached from or still attached to fibers. Moreover, the image of the second channel can be used for measuring the transmission absorption of ink related to a neighboring background image part without fiber and particle or a calibrated reference. From the results of the absorption measurement, the opacity of ink can be determined. In addition, with proper image analysis, the size, shape and area of ink and the amount of the inks contained in the image of the second channel are measurable. Also the concentration of the inks in the image can be measured if the suspension is prepared such that it has a fixed density of recycled pulp and a fixed layer thickness in the direction the light goes through. The ink concentration here can be defined and expressed as a ratio of the area all the inks occupied in the image related to that of all the fibers and particles. Thus, a parameter can be established by properly combining the ink concentration and the transmission absorption, which is equivalent to the effective residual ink concentration (ERIC value), but independent of the distribution of ink particle sizes. Furthermore, the image of the first channel can be used for determining the size and spectral characteristics of a particle or fiber in the image including color locus (L*, a*, b* values) with the help of proper image processing.

In accordance with the invention, the characteristics of particles or inks at other wavelength(s) can also be measured by changing the filter. For example, the image of the second channel formed with a filter of 700 nm can be used for measuring the absorption coefficients of a particle in the image at this wavelength and also determining the concentration of inks or particles visible at 700 nm. From the results of the absorption measurement and ink or particle concentration, a new parameter can be established, which can be equivalent to the ink elimination (IE) or the ink detachment (ID), but independent of the distribution of ink particle sizes.

According to the invention, the equipment can be modified for real-time identification of the fibers and fiber-based particles contained in recycled pulp or pulp from the non-fiber particles. In the modified equipment, the filter in the second channel is replaced by a polarizer, oriented perpendicular to the exit polarizer in the first channel. With this modification, the second channel outputs a polarizing image of fibers and particles in the recycled pulp or pulp, also insensitive to the fibers' orientation, but with a dark or bright background. In the image having dark background detected by the second or first image sensor, all the non-fiber particles contained in the recycled pulp or pulp sample are hidden by the dark background and therefore become invisible. Thus, by comparing the images of the both channels, it is feasible to distinguish the fibers and fiber-based particles from the non-fiber particles or to recognize which particles are fibrous and which ones are non-fiber particles.

The method and equipment of the present invention can be adapted for use for measurement of recycled pulp or pulp under on-line conditions. In principle, the equipment can also be further modified, for example to have three channels or more so that more measurement assignments can be performed simultaneously. In addition, the equipment of the invention can be used in the reflection mode. The principle and features of this invention will become more apparent from the following description in conjunction with the accompanying drawings.

### BRIEF DESCRIPTION OF THE DRAWINGS

FIG. 1 is a schematic diagram of the equipment of the present invention for real-time and/or on-line evaluation of recycled pulp or pulp, especially for real-time and/or on-line measurement of the sizes and optical characteristics of ink particles in recycled pulp.

FIG. 2 is a schematic diagram of the equipment of the present invention when it is modified for real-time and/or on-line identification of the fibers and fiber-based particles contained in recycled pulp or pulp from the non-fiber particles.

### DESCRIPTION OF THE PREFERRED EMBODIMENT

The method of the present invention uses imaging equipment for measuring the optical characteristics and sizes of the intended particles contained in recycled pulp or pulp and for distinguishing the fibers and fiber-based particles from the non-fiber particles. The recycled pulp or pulp sample used in the equipment of the invention is a suspension or liquid, in which fibers and particles of recycled pulp or pulp are immersed and distributed. Fiber suspension sample does not need special and time-consuming preparation procedure and it is convenient to be further used for measurement under the on-line condition with the help of proper means that holds and guides the suspension going through the measurement equipment to be used. With a fiber suspension sample, it is considerable to carry out both the transmission and reflectance measurement. In the description below, the equipment of the invention is a transmission imaging photometer for real-time and/or on-line measurement of recycled pulp or pulp, which shall be considered in all respects as illustrative and not restrictive.

The equipment of the invention is an imaging photometer, which may consist of one or two imaging channels or more. The method of the present invention respectively uses a one-channel imaging photometer for measurement of recycled pulp or pulp in laboratory and a photometer of two imaging channels or more for real-time evaluation and measurement of recycled pulp or pulp. Because the main objective of the present invention is to provide a method and equipment as a solution for real-time and/or on-line measurement of recycled pulp and pulp, the description of the invention below are mainly focused on the method of the invention and its equipment consisting of two imaging channels.

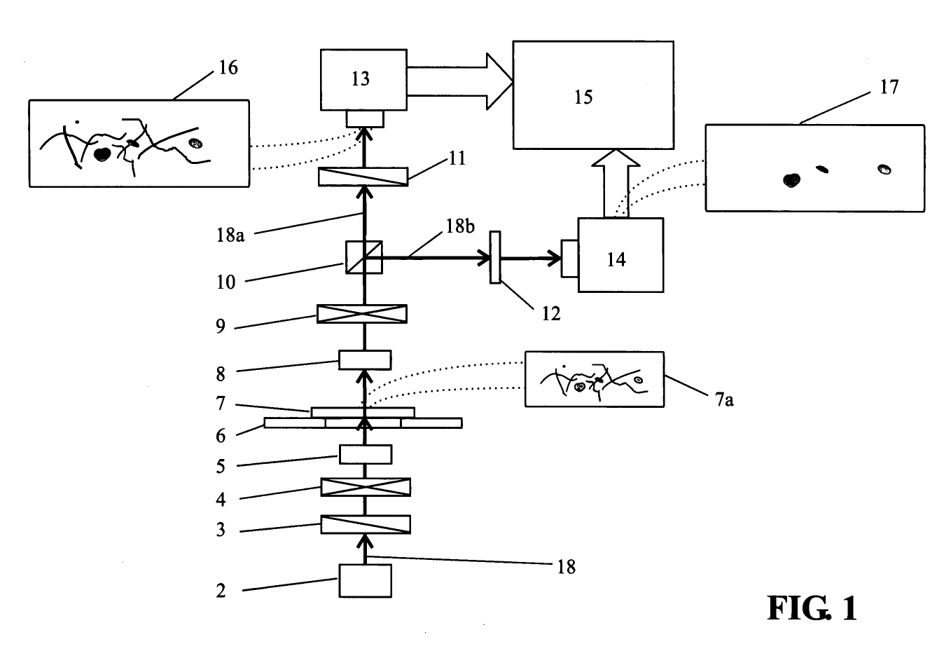

FIG. 1 schematically illustrates the arrangement of the two-channel imaging photometer of the present invention for real-time measurement of recycled pulp or pulp. The photometer comprises a light source 2, an entrance polarizer 3 (azimuth P₁=0°), a first quarter-wave retarder 4 (orientation angle φ₁), a condenser 5, a sample unit 6, an objective 8, and a second quarter-wave retarder 9 (orientation angle φ₂), a beamsplitter 10, an exit polarizer 11 (azimuth P₂), a bandpass spectral filter 12, and two image sensors 13 and 14 in connection to an image-processing unit 15. The light source 2 can be one as used in a microscope or an assembly comprising proper laser diode or diodes at the wavelengths as wished and it generates a light beam 18 having a broad spectrum, preferably in the visible and near infrared range. The image sensors 13 and 14 may be CCD or CMOS cameras or the like. The light beam 18 enters entrance polarizer 3 and it is linearly polarized. The linearly polarized light goes through the quarter-wave retarder 4 and it is focused to a recycled pulp or pulp sample 7 under test on the sample unit 6 through the condenser 5. The sample 7 is a suspension containing recycled fibers and particles. The sample unit 6 may be a microscope slide, on which the sample 7 is distributed and covered with a cover glass. The sample 7 has a small part 7a (as exaggeratedly illustrated in FIG. 1), which is being illuminated by the light 18. The light 18 emergent from the sample part 7a is imaged and focused by the objective 8 and it passes through the quarter-wave retarder 9 and then divided into two component beams 18a and 18b by the beamsplitter 10. The beam 18a goes through the exit polarizer 11 and reaches the image sensor 13. The exit polarizer 11 is aligned to be parallel or perpendicular to the entrance polarizer 3, i.e. P₂=0° or P₂=90°. The quarter-wave retarders 4 and 9 are preferably achromatic in the wavelength range of the equipment with their retardation errors negligible. They are oriented perpendicular or parallel to each other such that they both make an angle of 45° related to the entrance polarizer 3, i.e. φ₁=45° and φp₂=−45° or φ₁=45° and φ₂=45°. The spectral filter 12 may be a filter installed in a filter wheel (not shown) or a tunable spectral filter so that its wavelength selection is changeable. The beam 18b is filtered by the spectral filter 12 and only the light component at the wavelength of the filter 12 passes through and is detected by the image sensor 14. The images detected by the image sensors 13 and 14, which preferably are identical, are interfaced and sent to the image-processing unit 15.

In the channel of the photometer in FIG. 1, in which the image sensor 13 is, the entrance polarizer 3, quarter-wave retarders 4 and 9, and exit polarizer 11 constitute an imaging ellipsometer. However, in the other channel, in which the image sensor 14 is, there is only one polarizer (polarizer 3) and a second polarizer is missing so that it functions as an ordinary imaging photometer. The image of a pulp fiber from the sample part 7a created in the channel of the sensor 13 behind the exit polarizer 11 is insensitive to the fiber's orientation and determined only by the fiber's properties related to the polarized light if φ₁=45° and φ₂=−45° or φ₁=45° and φ₂=45° for P₂=0° or P₂=90° (Ye, C., Patent Application of Finland, No. 20060715, “Method and equipment especially for measurement of intact pulp fibers”). For P₂=0°, φ₁=45° and φ₂=−45° or P₂90°, φ₂=45° and φ₂=45° the image sensor 13 will detect a magnified picture 16 of all fibers and particles contained in the sample part 7a with a bright background image, independently of the fibers' orientations. At the same time, in the other channel, the image sensor 14 will detect and output a magnified picture 17 of ink particles contained in the sample part 7a if a bandpass filter in the near infrared range, preferably at 950 nm, is used as the filter 12, because inks absorb light at 950 nm or in the near infrared range several orders stronger than fibers and non-ink particles.

With the image 17 formed when the filter 12 is a bandpass filter of 950 nm, the transmission absorption k of an ink particle can be measured and ascertained related to a neighboring background image segment without fiber and particle, which can be selected with the help of the image 16, or a calibrated reference. From the obtained results for absorption measurement, the opacity of ink can be determined. In addition, by image analysis, the size, shape and area of an ink particle and the amount of the inks contained in the image 17 are measurable. Also the ink concentration of the image 17 can be measured if the suspension is prepared such that it has a fixed density of recycled pulp and a fixed layer thickness in the direction the light goes through. The ink concentration cᵢₙₖ of an image can be defined and expressed as a ratio of the area all the inks occupied in the image related to that of all the fibers and particles. Thus, a parameter can be established or generated by properly combining the ink concentration cᵢₙₖ and the transmission absorption k, which is equivalent to the effective residual ink concentration (ERIC value), but independent of the distribution of ink particle sizes.

In contrary to the image 17, in the polarizing image 16 of the channel of the image sensor 13 all fibers and particles contained in the sample part 7a are visible. Thus, by comparing the image 16 with the image 17, on which only inks are visible, it is feasible to recognize which particles in the image 16 are inks and to distinguish which inks are already detached from or still attached to fibers. Furthermore, the image 16 can be used for calculating and ascertaining the spectral characteristics of a particle including color locus (L*, a*, b* values) with the help of proper software for the image processing.

In accordance with the invention, in addition to 950 nm, the characteristics of inks at other wavelength(s) can be measured by changing or tuning the filter 12. For example, the wavelength of the filter 12 can be changed to 700 nm by adjusting the filter wheel or operating the tunable filter. The image 17 formed when the filter 12 is a bandpass filter of 700 nm can be used for measuring the absorption coefficients of ink in the image 17 at this wavelength, related to a neighboring background image segment without fiber and particle, which can be selected with the help of the image 16. From the obtained results of the absorption measurement, a new parameter can be established, which is equivalent to the ink elimination (IE) or the ink detachment (ID).

In another embodiment of the invention, the entrance polarizer 3, quarter-wave retarders 4 and 9, and exit polarizer 11 can be oriented with P₂=90°, φ₁=45° and φ₂=−45° or P₂0°, φ₁45° and φ₂=45° so that the image sensor 13 detects a magnified picture 16 of all fibers and fiber-based particles contained in the sample part 7a with a dark background, where there is no fiber and particle, independently of the fibers' orientations. The benefit obtained with a dark background image is higher contrast for better displaying or detecting fibers. The image 16 of the channel of the image sensor 13 with a dark background can be compared with the image 17 formed with a bandpass filter of 950 nm as the filter 12 and used to distinguish which inks are already detached from or still attached to fibers in the image 16.

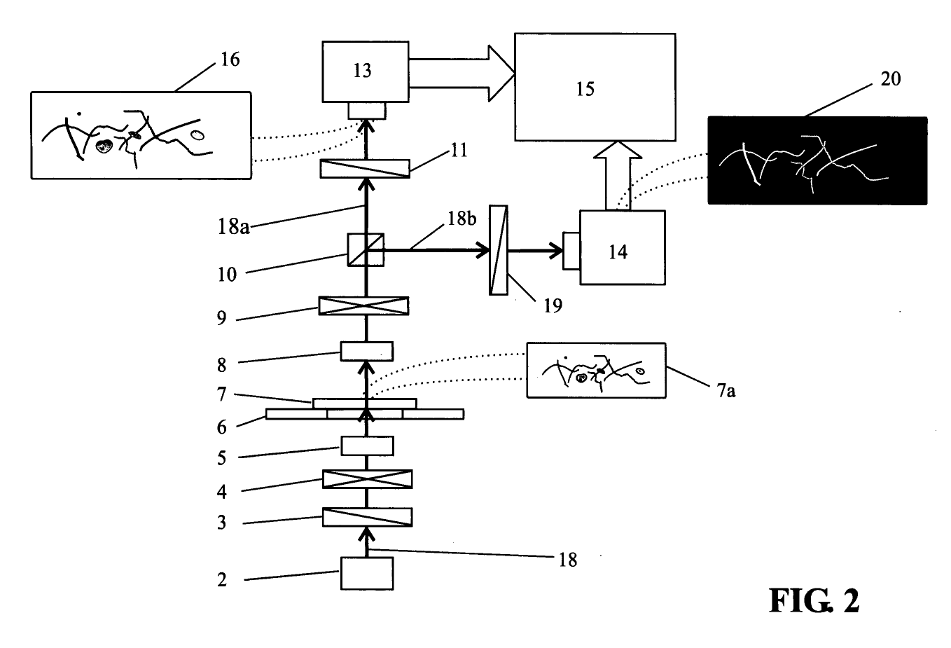

According to the present invention, the equipment in FIG. 1 can be modified so that it can be employed for real-time identification of the fibers and fiber-based particles contained in recycled pulp or pulp from the non-fiber particles. As shown in FIG. 2, the modified equipment is a further development of the arrangement of FIG. 1, in which the spectral filter 12 is replaced by a second exit polarizer 19 (azimuth P₃), which is oriented perpendicular to the exit polarizer 11 such that P₃=90° if P₂=0° or P₃=0° if P₂=90°. As an example, it is assumed in FIG. 2 that the quarter-wave retarders 4 and 9 and exit polarizer 11 are aligned such φ₁=45°, φ₂=−45° and P₂=0°. For φ₁=45°, φ₂=−45° and P₃=90°, the image sensor 14 will detect a magnified picture 20 of all fibers and particles contained in the sample part 7a with a dark background. The arrangement of the optical components in this channel is also insensitive to the fiber's orientation with the created image 20 determined only by the fiber's and fiber-based particles' properties related to the polarized light. However, all the non-fiber particles contained in the sample part 7a will be hidden by the dark background and they will become invisible by the sensor 14. Thus, by comparing the image 20 with the image 16 of the image sensor 13, it is feasible to distinguish the pulp fibers or fiber-based particles from the non-fiber particles or to recognize which particles are fibrous and which ones are non-fiber particles.

If there is no need for real-time measurement of recycled pulp or pulp, one-channel imaging equipment can be constructed based on the arrangement of FIG. 1 or FIG. 2 and used according to the method of the present invention. For example, the equipment can be constructed to be composed only of the channel of the image sensor 13. With the exit polarizer 11 parallel to the entrance polarizer 3, a first image of fibers and particles contained in the sample part 7a is acquired with the image sensor 13, which is equivalent to the image 16. After a first image is acquired, the exit polarizer 11 can be rotated by 90° to be perpendicular to the entrance polarizer 3 and the image sensor 13 detects a second image of fibers and particles contained in the sample part 7a, which is equivalent to the image 20 with a dark background. Then the exit polarizer 11 can be replaced by the filter 12, which may be a bandpass filter at an intended wavelength, e.g. 950 nm, and the image sensor 13 now can detect and output a third image of the sample part 7a, which is equivalent to the image 17 of the sample part 7a. Thus one can use and process the first, second and third images, which are sequentially acquired, and compare them with each other to evaluate and measure fibers and particles contained in the sample part 7a according to the method of the present invention as described above.

It should be obvious that the arrangements of FIG. 1 and FIG. 2 can be combined and simply further used for design and construction of equipment consisting of three imaging channels or more so that more measurement assignments can be performed simultaneously. In addition, the arrangements of FIG. 1 and FIG. 2 can be used or can be adapted to be used in the reflection mode.

It should be also obvious that the method and equipment of the present invention can further be used or adapted to be used for measurement of recycled pulp or pulp under on-line conditions. For this purpose, the sample unit 6 in FIG. 1 or FIG. 2 needs to be replaced by a proper capillary (e.g. KajaaniMAP or Pulpexpert) or a flowing cuvette, which holds and guides the sample 7 so that fibers and particles contained in the sample 7 will continuously pass through the capillary or cuvette at a speed as high as the used image sensors allow.

There are capillaries or flowing cells available that hold suspension and can guide pulp fibers in the suspension flowing parallel or approximately parallel to one another, predominately along the flowing direction of the suspension. According to the present invention, the arrangement of FIG. 1 or FIG. 2 can be simplified when such a capillary or flowing cell is used as the sample unit 6. The capillary or flowing cell can be mounted so that the suspension in capillary or flowing cell flows at 45° related to the entrance polarizer 3 and fibers contained in the suspension are guided to be parallel or approximately parallel to one another, moving predominately along the flowing direction of said suspension. In this case, the quarter-wave retarders 4 and 9 can be removed if so wished.

The present invention may be embodied or adapted in other specific form and/or further embodiments without departing from the spirit and basic characteristics thereof. The embodiments given in this description shall be considered in all respects as illustrative and not restrictive. Variations will be apparent to those skilled in the art.

1. A method for evaluation of recycled pulp or pulp by means of equipment that contains at least one imaging channel and comprises a light source, an entrance polarizer, a sample unit, an exit polarizer, a filter, at least an image sensor and an image-processing unit for image and data processing, the method comprising the steps of:
placing the recycled pulp or pulp in the sample unit,
generating at least one image of fibers and particles contained in the recycled pulp or pulp selected for measurement with the equipment, and
using the at least one image for measuring and evaluating the fibers and particles selected for measurement.

2. The method of claims 1 wherein the equipment contains one image sensor and one imaging channel with said image sensor as the detector, constructed with said light source, entrance polarizer, sample unit, exit polarizer and image sensor arranged along a light beam axis in series in the recited order with said image sensor interfaced to said image-processing unit, and said method further comprises the steps of generating a first image of fibers and particles selected for measurement by orienting said exit polarizer parallel to said entrance polarizer, detecting said first image of fibers and particles by said image sensor and outputting said first image to said image-processing unit, generating a second image of fibers and particles selected for measurement by orienting said exit polarizer perpendicular to said entrance polarizer, detecting said second image of said fibers and particles by said image sensor and outputting said second image to said image-processing unit, generating a third image of fibers and particles selected for measurement by replacing said exit polarizer with said filter, detecting said third image of said fibers and particles by said image sensor and outputting said third image to said image-processing unit, and processing said first, second and third images in said image-processing unit and comparing said first, second and third images with one another for measuring and evaluating said fibers and particles selected for measurement.

3. The method of claim 2 wherein the recycled pulp or pulp in said sample unit is immersed in suspension and said sample unit typically is a microscope sample slide or a capillary or cuvette that holds said suspension with fibers and particles immersed therein and is constructed and mounted such that said fibers are parallel or approximately parallel to one another at a direction at 45° related to said entrance polarizer.

4. The method of claim 2 wherein the equipment further comprises a first quarter-wave retarder and second quarter-wave retarder, which are identical and achromatic over the wavelength range of said equipment, and said first and second quarter-wave retarders are inserted between said entrance polarizer and sample unit and between sample unit and exit polarizer, respectively, having their axes oriented perpendicular or parallel to each other and at 45° related to said entrance polarizer.

5. The method of claim 4 wherein the recycled pulp or pulp in said sample unit is immersed in suspension and said sample unit is a microscope sample slide or a capillary or cuvette that holds said suspension with fibers and particles immersed therein for measurement in said equipment.

6. The method of claim 2 wherein the equipment further comprises an objective or an objective and a condenser and said objective is or said objective and condenser are inserted into said beam, located between said sample unit and image sensor or between said sample unit and image sensor and between said light source and sample unit, respectively.

7. The method of claim 2 wherein the first or second image of fibers and particles is used and processed for determining the size, shape and area of a particle or fiber in said first or second image and for determining and calculating the spectral characteristics of a particle or fiber in said first or second image.

8. The method of claim 2 wherein the first and second images of fibers and particles are compared with each other and processed for recognizing which particles in said first image are fiber-based particles and for distinguishing fibers and fiber-based particles from non-fiber particles in said first image.

9. The method of claim 2 wherein the filter is a spectral filter of a predetermined wavelength and in said third image of fibers and particles only particles visible at said predetermined wavelength are visible.

10. The method of claim 2 wherein the third image is used and processed in said image-processing unit for determining the size, shape and area of a particle visible at said predetermined wavelength and the amount and concentration of particles visible at said predetermined wavelength in said third image, measuring the transmission absorption and opacity of a particle in said third image related to a neighboring background image part without fiber and particle or a calibrated reference, and measuring a parameter established by combining said transmission absorption and said particle concentration.

11. The method of claim 2 wherein the predetermined wavelength of said spectral filter is in the near infrared range particles visible in said third image are ink particles, and said parameter established by combining said transmission absorption and said particle concentration is equivalent to an effective residual ink concentration (ERIC value), but independent of the size distribution of inks.

12. The method of claim 2 wherein the predetermined wavelength of said spectral filter is 700 nm, and particles visible in said third image are ink particles, and said parameter established by combining said transmission absorption and said particle concentration is equivalent to the ink elimination (JE) or the ink detachment (ID), but independent of the size distribution of inks.

13. The method of claim 2 wherein the first or second image of fibers and particles and said third image of ink particles are compared with each other and processed for recognizing which particles in said first or second image are inks and for distinguishing which inks are already detached from or still attached to fibers.

14. The method of claim 1 wherein the equipment contains a first image sensor and a second image sensor, both interfaced to said image-process unit, and two imaging channels connected to said first and second image sensors, respectively, and further comprises a beam-splitter and said equipment is constructed with said light source, entrance polarizer, sample unit, beam-splitter, exit polarizer, filter, first and second image sensors arranged to form said two imaging channels such that said exit polarizer and filter are respectively in said two imaging channels, positioned before said first and second image sensors, and said method further comprises the steps of placing said recycled pulp or pulp in said sample unit, generating and forming image of said fibers and particles selected for measurement in said channel connected to said first image sensor by orienting said exit polarizer parallel or perpendicular to said entrance polarizer, detecting said image of fibers and particles in said channel of said first image sensor by said first image sensor and outputting said image to said image-processing unit, generating and forming image of said fibers and particles selected for measurement behind said filter in said channels connected to said second image sensor, detecting said image of fibers and particles in said channel of said second image sensor by said second image sensor and outputting said image to said image-processing unit, and processing said images detected by said first and second image sensors and comparing said images with each other for measuring and evaluating fibers and particles in said images.

15. The method of claim 14 wherein the light emergent from said light source goes through said entrance polarizer and sample unit with said recycled pulp or pulp placed therein, and is divided by said beam-splitter into two component beams with one of said component beams detected by said first image sensor after passing through said exit polarizer and the other one by said second image sensor after passing through said filter, and images detected by said first and second image sensors are interfaced to said image-processing unit where said detected images are digitized and processed.

16. The method of claim 14 wherein the recycled pulp or pulp in said sample unit is immersed in suspension and said sample unit typically is a microscope sample slide equipped with a specimen guide or a capillary or cuvette that holds said suspension with fibers and particles immersed therein for measurement in said equipment and is constructed and mounted such that said fibers are guided to be parallel to one another, moving along at a direction at 45° related to said entrance polarizer.

17. The method of claim 14 wherein the equipment further comprises a first quarter-wave retarder and second quarter-wave retarder, which are identical and achromatic over the wavelength range of said equipment, and light emergent from said light source goes through said entrance polarizer, first quarter-wave retarder, sample unit with said recycled pulp or pulp placed therein and second quarter-wave retarder, and is divided by said beam-splitter into two component beams with one of said component beams detected by said first image sensor after passing through said exit polarizer and the other one by said second image sensor after passing through said filter, and images detected by said first and second image sensors are interfaced to said image-processing unit where said detected images are digitized and processed.

18. The method of claim 17 wherein the light source, entrance polarizer, first quarter-wave retarder, sample unit, second quarter-wave retarder, beam-splitter and exit polarizer are arranged in series in the recited order and oriented with said first and second quarter-wave retarders having their axes perpendicular or parallel to each other and at 45° related to said entrance polarizer.

19. The method of claim 17 wherein the sample unit is a microscope sample slide equipped with a specimen guide or a proper capillary or cuvette that holds said suspension and guides fibers and particles in said sample unit sequentially passing through for measurement in said equipment.

20. The method of claim 14 wherein the equipment further comprises an objective or an objective and a condenser and said objective is or said objective and condenser are inserted into said beam, located between said sample unit and beam-splitter or between said sample unit and beam-splitter and between said light source and sample unit, respectively.

21. The method of claim 14 wherein the image of fibers and particles detected by said first image sensor is used and processed for determining the size, shape and area of a particle or fiber in said image and for determining and calculating the spectral characteristics of a particle or fiber in said image.

22. The method of claim 14 wherein the filter is a spectral filter of a predetermined wavelength and said image detected by said second image sensor is used and processed in said image-processing unit for determining the size, shape and area of a particle visible at said predetermined wavelength and the amount and concentration of particles visible at said predetermined wavelength in said image of said second image sensor, measuring the transmission absorption and opacity of a particle in said image of said second image sensor related to a neighboring background image part without fiber and particle or a calibrated reference, and measuring a parameter established by combining said transmission absorption and said particle concentration.

23. The method of claim 22 wherein the predetermined wavelength of said spectral filter is in the near infrared range particles visible in said image detected by said second image sensor are ink particles, and said parameter established by combining said transmission absorption and said particle concentration is equivalent to the effective residual ink concentration (ERIC value), but independent of the size distribution of inks.

24. The method of claim 22 wherein the predetermined wavelength of said spectral filter is 700 ran, and particles detected by said second image sensor are ink particles, and said parameter established by combining said transmission absorption and said particle concentration is equivalent to the ink elimination (IE) or the ink detachment (ID), but independent of the size distribution of inks.

25. The method of claim 14 wherein the image of fibers and particles detected by said first image sensor and said image of ink particles detected by said second image sensor are compared with each other and processed for recognizing which particles in said image of said first image sensor are inks and for distinguishing which inks are already detached from or still attached to fibers.

26. The method of claim 14 wherein the filter is a second exit polarizer, oriented perpendicular to said exit polarizer so that said images of fibers and particles detected by said first and second image sensors have bright and dark or dark and bright backgrounds, having the highest and lowest or lowest and highest light intensity, respectively, when said recycled pulp or pulp is absent in said sample unit.

27. The method of claim 26 wherein the image having dark background detected by said second or first image sensor fibers and fiber-based particles of said recycled pulp or pulp are visible while non-fiber particles are not, hidden by said dark background, and said image having dark background detected by said second or first image sensor is used and processed for determining the size, shape and area of a fiber or a fiber-based particle in said image of second or first image sensor.

28. The method of claim 14 wherein the images of fibers and particles detected by said first and second image sensors are compared with each other and processed for recognizing which particles in said images are fiber-based particles and for distinguishing fibers and fiber-based particles from non-fiber particles.

29. The method of claim 2 wherein the recycled pulp or pulp in said sample unit is immersed in suspension and said first and second image sensors are CCD or CMOS cameras.

30. Equipment for measurement of recycled pulp or pulp, comprising:
a light source,
an entrance polarizer in operative engagement with the light source,
a sample unit in operative engagement with the entrance polarizer,
a beam-splitter in operative engagement with the sample unit,
an exit polarizer in operative engagement with the beam-splitter,
a filter in operative engagement with the beam-splitter,
a first image sensor in operative engagement with the exit polarizer,
a second image sensor in operative engagement with the filter, and
an image-processing unit for image and data processing in operative engagement with the first image sensor.

31. The equipment of claim 30 wherein the light source is of a type generating light beam having a spectrum in a predetermined wavelength range and is a light source in the visible and infrared range or an assembly comprising proper laser diode or diodes at the wavelengths.

32. The equipment of claim 30 wherein the recycled pulp or pulp is immersed in suspension and placed in said sample unit and said first and second image sensors preferably are CCD or CMOS cameras.

33. The equipment of claim 30 wherein the equipment contains two imaging channels connected to said first and second image sensors, respectively, and light emergent from said light source goes through said entrance polarizer and sample unit with said recycled pulp or pulp placed therein, and is divided by said beam-splitter into two component beams with one of said component beams detected by said first image sensor after passing through said exit polarizer and the other one by said second image sensor after passing through said filter, and images detected by said first and second image sensors are interfaced to said image-processing unit where said detected images are digitized and processed.

34. The equipment of claim 33 wherein the light source, entrance polarizer, sample unit, beam-splitter and exit polarizer are arranged in series in the recited order with said exit polarizer oriented parallel or perpendicular to said entrance polarizer so that said first image sensor detects and outputs an image of fibers and particles contained in said recycled pulp or pulp, which is bright or dark, having the highest or lowest light intensity, respectively, when said recycled pulp or pulp is absent in said sample unit.

35. The equipment of claim 34 wherein the sample unit typically is a capillary or cuvette that holds said suspension and guides fibers and particles in said suspension sequentially passing through for measurement in said equipment and is constructed and mounted such that said fibers are guided to be parallel or approximately parallel to one another, moving along a direction at 45° related to said entrance polarizer.

36. The equipment of claim 30 wherein the equipment further comprises a first quarter-wave retarder and a second quarter-wave retarder, which are identical and achromatic over said wavelength range.

37. The equipment of claim 30 wherein the equipment contains two imaging channels connected to said first and second image sensors, respectively, and light emergent from said light source goes through said entrance polarizer, first quarter-wave retarder, sample unit with said recycled pulp or pulp placed therein and second quarter-wave retarder, and is divided by said beam-splitter into two component beams with one of said component beams detected by said first image sensor after passing through said exit polarizer and the other one by said second image sensor after passing through said filter, and images detected by said first and second image sensors are interfaced to said image-processing unit where said detected images are digitized and processed.

38. The equipment of claim 37 wherein the light source, entrance polarizer, first quarter-wave retarder, sample unit, second quarter-wave retarder, beam-splitter and exit polarizer are arranged in series in the recited order and oriented with said exit polarizer parallel or perpendicular to said entrance polarizer and said first and second quarter-wave retarders having their axes perpendicular or parallel to each other and at 45° related to said entrance polarizer so that said first image sensor detects and outputs an image of fibers and particles contained in said recycled pulp or pulp, which is bright or dark, having the highest or lowest light intensity, when said recycled pulp or pulp is absent in said sample unit.

39. The equipment of claim 38 wherein the sample unit is a microscope sample slide equipped with a specimen guide or a capillary or cuvette that holds said suspension and guides fibers and particles in said suspension sequentially passing through for measurement in said equipment.

40. The equipment of claim 33 wherein the equipment further comprises an objective or an objective and a condenser and said objective is or said objective and condenser are inserted into said beam, located between said sample unit and beam-splitter or between said sample unit and beam-splitter and between said light source and sample unit, respectively.

41. The equipment of claim 33 wherein the image of fibers and particles detected by said first image sensor is used and processed in said image-processing unit for determining the size, shape and area of a particle or fiber in said image, and determining and calculating the spectral characteristics of a particle or fiber.

42. The equipment of claim 30 wherein the filter is a replaceable spectral filter of a predetermined wavelength, one of spectral filters installed in a filter wheel or a tunable spectral filter with the wavelength selection changeable.

43. The equipment of claim 30 wherein the second image sensor detects and outputs an image of particles in said recycled pulp or pulp at said predetermined wavelength and said image of particles detected by said second image sensor is processed and used for determining the size, shape and area of a particle visible at said predetermined wavelength and the amount and concentration of particles visible at said predetermined wavelength in said image, measuring the transmission absorption and opacity of a particle in said image related to a neighboring background image part without fiber and particle or a calibrated reference, and measuring a parameter established by combining said transmission absorption and said particle concentration.

44. The equipment of claim 42 wherein the predetermined wavelength of said spectral filter is in near infrared range and said second image sensor detects and outputs an image in said near infrared range or of 950 run so that said particles detected by said second image sensor are inks and said parameter established by combining said transmission absorption and said particle concentration is equivalent to an effective residual ink concentration (ERIC value), but independent of the size distribution of inks.

45. The equipment of claim 42 wherein the predetermined wavelength of said spectral filter is 700 nm, and said second image sensor detects and outputs an image of 700 nm so that said particles detected by said second image sensor are inks and said parameter established by combining said transmission absorption and said particle concentration at 700 nm is equivalent to the ink elimination (IE) or the ink detachment (ID), but independent of the size distribution of inks.

46. The equipment of claim 33 wherein the image of fibers and particles detected by said first image sensor and said image of particles at said predetermined wavelength detected by said second image sensor are compared with each other and processed for recognizing which particles in said image of said first image sensor are inks and for distinguishing which inks are already detached from or still attached to fibers.

47. The equipment of claim 30 wherein the filter is a second exit polarizer, oriented perpendicular to said exit polarizer so that said images of fibers and particles detected by said first and second image sensors have bright and dark or dark and bright backgrounds, having the highest and lowest or lowest and highest light intensity, respectively, when said recycled pulp or pulp is absent in said sample unit.

48. The equipment of claim 47 wherein the image having dark background detected by said second or first image sensor fibers and fiber-based particles of said recycled pulp or pulp are visible while non-fiber particles are not and said image having dark background detected by said second or first image sensor is processed and used for determining the size, shape and area of a fiber or a fiber-based particle in said image of said second or first image sensor.

49. The equipment of claim 30 wherein the image having bright background detected by said first or second image sensor, in which fibers and particles in said recycled pulp or pulp are visible, and said image having dark background detected by said second or first image sensor, in which fibers and fiber-based particles of said recycled pulp or pulp are visible and non-fiber particles are not, are compared and processed to distinguish the fibers and fiber-based particles in said image detected by said first or second image sensor from the non-fiber particles.

50. The equipment of claim 30 wherein the equipment further comprises means for reflecting light and said equipment is modified to work in the reflection model such that light beam emergent from said light source is incident, generally at an angle, on said recycled pulp or pulp in said sample unit after passing through said entrance polarizer or said entrance polarizer and first quarter-wave retarder and reflected by said recycled pulp or pulp with the help of said means for reflecting light, and said reflected beam is divided by said beam-splitter or divided by said beam-splitter after going through said second quarter-wave retarder into two component beams with one of said component beams detected by said first image sensor after passing through said exit polarizer and the other one by said second image sensor after passing through said filter.

51. The equipment of claim 50 wherein the entrance polarizer and exit polarizer are oriented with said exit polarizer parallel or perpendicular to said entrance polarizer or said entrance polarizer, first quarter-wave retarder, second quarter-wave retarder and exit polarizer are oriented with said first and second quarter-wave retarders having their axes perpendicular or parallel to each other and oriented at 45° related to and said exit polarizer oriented parallel or perpendicular to said entrance polarizer.

52. The equipment of claim 50 wherein the filter is a replaceable spectral filter of a predetermined wavelength or a second exit polarizer oriented perpendicular to said exit polarizer.

53. The equipment of claim 50 wherein the equipment further comprises an objective or an objective and a condenser and said objective is or said objective and condenser are inserted into said beam, located between said sample unit and beam-splitter or between said sample unit and beam-splitter and between said light source and sample unit, respectively.
